(19) United States
(12) Patent Application Publication
(10) Pub. No.: US 2002/0122026 A1
(43) Pub. Date: Sep. 5, 2002

(54) Fingerprint sensor and position controller

(76) Inventor: Dean Warren Bergstrom, West Linn, OR (US)

Correspondence Address: LAW OFFICE OF KAREN DANA OSTER, LLC, PMB 1020, 15450 SW BOONES FERRY ROAD #9, LAKE OSWEGO, OR, 97035, US

(21) Appl. No.: 09/798,851

(22) Filed: Mar. 1, 2001

(51) Int. Cl. G09G 5/08

(52) U.S. Cl. 345/157

(57) ABSTRACT

A system for sensing the coordinate position and an identification of a finger. The sensed position and sensed identification information are substantially simultaneously and continually analyzed. The coordinate position information is used to control a visual cue on a display. The identification information is used to limit access to a computer system.

### BACKGROUND OF THE INVENTION

The present invention relates generally to a computer access security system for identifying fingerprints and controlling the position of a cursor on an associated display screen, and more particularly to a device that is capable of performing both functions simultaneously.

A fingerprint is an impression of the lines and whorls on the inner surface of the end joint of the finger. Points where ridges in the fingerprint terminate or bifurcate are referred to as minutiae or characteristics. Every fingerprint has a significant number of minutiae (as many as 80) positioned at various diverse locations. Inasmuch as fingerprints are unique to the individual, a fingerprint can be sampled and the sample compared to a reference fingerprint to identify a person. If the reference and sampled fingerprint match, identity is confirmed. Systems that perform fingerprint sensing and matching can be used for controlling access to information, such as data contained in a computer system, or access to a physical area, such as a building or a vehicle. Fingerprint sensing and matching systems can be used to identify whether use of an appliance or equipment is authorized. In addition, such systems can be used to identify a consumer in order to authorize a credit or debit to the consumer's account in a retail purchase transaction. Fingerprint sensing and matching systems can also be used to perform a security check in a regulated purchase transaction, such as the sale of a firearm. Fingerprint sensing and matching systems eliminate the need for keys, personal identification numbers, passwords, and other means of identification.

There are a variety methods for sampling or sensing fingerprints, including optical, electrical, and other technologies. For example, U.S. Pat. No. 5,239,590 to Yamamoto (“the Yamamoto reference”) discloses an optical detection method used for fingerprint sensing. The Yamamoto reference describes an image input system that uses a prism: the end joint of a finger is placed in contact with one surface, and a light illuminates another surface, while the reflection is captured by a charge coupled device (CCD) camera directed at a third surface. Electrical detection methods that detect pressure differentials may also be used for fingerprint sensing. One example of this type of fingerprint sensing method is shown in U.S. Pat. No. 5,429,006 to Tamori (“the Tamori reference”). The Tamori reference discloses a thin, flexible film with a conductive surface suspended over a matrix of switching elements. When ridges of a fingerprint press against the film, the conductive surface comes into contact with the switching elements, causing them to switch on according to the fingerprint pattern. Another type of electrical method detects surface contact. As one example, U.S. Pat. No. 5,325,442 to Knapp (“the Knapp reference”), discloses a fingerprint sensor that employs an array of sensing electrodes. When a finger is placed in contact with the array of sensing electrodes, a capacitance develops between each sensing electrode and individual portions of the finger surface. A fingerprint image is constructed by measuring the capacitance associated with each sensor. Other technologies use electrical resistance, thermal value measurements, or other means to sense fingerprint topology. Generally, once a fingerprint image is sensed, it is divided into small pixels to facilitate binary operations employed by fingerprint matching techniques.

Like fingerprint sensing, fingerprint matching may be performed in various ways, including matching minutiae, ridge pattern, or both. Fingerprint matching schemes involve comparing some form of a sensed fingerprint image to a reference image. The entire sensed fingerprint image, or only a portion of the fingerprint, may be compared with the reference image. While the comparison may be on a pixel-by-pixel basis, more sophisticated methods have been developed to increase the efficiency of the comparison process. For example, the matching process may involve a comparison of fingerprint characteristics or minutiae. U.S. Pat. No. 4,747,147 to Sparrow discloses a system in which a fingerprint is scanned radially, and each irregularity is assigned type code, angular, and distance coordinates. The collection of coordinate sets for each irregularity from a scanned image and a reference image are then compared. Alternatively, the matching process may involve comparison of other descriptions of fingerprint topology. The Yamamoto reference, for example, discloses a method whereby each pixel is assigned a direction, and fingerprint verification is determined by computing one or more of three described indices of correlation. These methods are representative and are not the exclusive means for performing fingerprint matching.

Computer operating systems and application software programs employ various methods to allow users to enter data or otherwise interact with the computer. The way in which the user interacts with the computer is generally referred to as the user interface. A user interface can be textual or graphic, and can include a number of types of devices that can be used to interact with the user interface (“interactive input device”). Many user interfaces include a visual cue, such as a cursor, that is controlled by an interactive input device, such as a mouse. An arrow, a crosshair, or other icon may be used as a visual cue. Movement of the interactive input device's control mechanism results in correlated movement of the visual cue on the display screen. Interactive input devices of this type can be used to perform a number of functions: they can be used to indicate where text should be placed in a textual document or where a geometric object should be placed in a graphical document. In some applications, the user moves the visual cue to the desired location and clicks a mouse button. In other applications, the user selects the object by placing the visual cue over the object, depressing a mouse button, dragging the object to the new location, and then releasing the mouse button. In addition, interactive input devices can be used to select graphical objects, menu items, or text. They can also be used to input numeric values when used with graphic objects that have the appearance of a physical device. For example, an interactive input device can be controlled to cause the visual cue to move in such a way that it appears to change the position of a sliding knob or rotary dial. Another use for interactive input devices is to select a particular option, such as “yes/no” on a graphic object that appears as a button. Examples of interactive input devices that can be used to control a visual cue such as a cursor include a computer mouse, a joystick, a trackball, a touch-sensitive pen, and a light-sensitive pen. The foregoing examples of functions are illustrative, and it is generally recognized that an interactive input device can perform additional functions. Similarly, the foregoing examples of interactive input devices are illustrative.

Movement of a member, such as the end joint of the finger, on a surface that includes at least one sensor is another type of interactive input device that controls the position and movement of a visual cue. An example of a device of this type is set forth in U.S. Pat. No. 5,956,019 to Bang, et al. (“the Bang reference”). The device disclosed in the Bang reference consists of a touch-sensitive pad with a thumb switch that produces cursor control output signals. Using the Bang device, the user's finger controls the movement and position of the cursor on a display.

Generally, cursors move in a two-dimensional plane, and interactive input devices such as trackballs and computer mice are capable of providing coordinate information in only two dimensions. In contrast, a touch-sensitive pad can optionally provide three-dimensional coordinate input. In addition to providing x and y coordinate information responsive to movement of the member from side to side, forward and back, z coordinate information may be obtained in accordance with the pressure exerted by the member on the contact surface.

The touch-sensitive screen is related to the touch-sensitive pad. Generally, the touch-sensitive screen functions only to select an option and does not control a cursor or other visual cue. For example, to select an object on a touch-sensitive screen, the user points at the object with his finger.

### BRIEF SUMMARY OF THE INVENTION

Known systems use a contact surface and employ techniques directed to fingerprint sensing and matching for identification purposes or employ techniques for sensing contact location to control the position of a cursor on a display screen. None of the known systems use the sensed information for both purposes.

The present invention performs both fingerprint sensing and matching for identification purposes, and controls the position of a cursor on a display screen for data input purposes. In the present invention, a single contact surface is used, and both functions are performed substantially contemporaneously.

One preferred embodiment of the present invention is directed to a system comprising a contact surface that includes position sensors for sensing the coordinate position of a finger and identification sensors for sensing an identification of the finger. In addition, this preferred embodiment includes a processor for receiving the sensed information and continually analyzing the coordinate position and identification information. The coordinate position information is used to control a cursor or other visual cue on a display. The identification information is used to limit access to the computer system.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 shows an exemplary embodiment of the security system of the present invention, illustrating sensing of a fingerprint image and a two-dimensional position.

FIG. 2 shows an exemplary embodiment of the security system of the present invention, illustrating sensing of a fingerprint image and a one-dimensional position.

FIG. 3 is a flow diagram of one preferred embodiment of a security system in accordance with the present invention.

FIG. 4 is a is a block diagram of one preferred embodiment of a security system in accordance with the present invention.

### DETAILED DESCRIPTION OF THE INVENTION

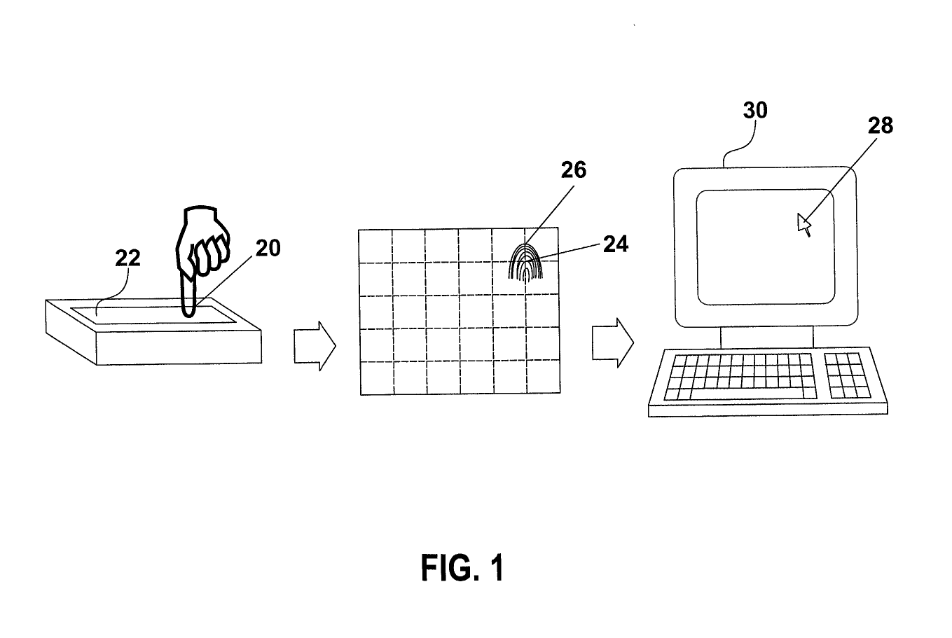

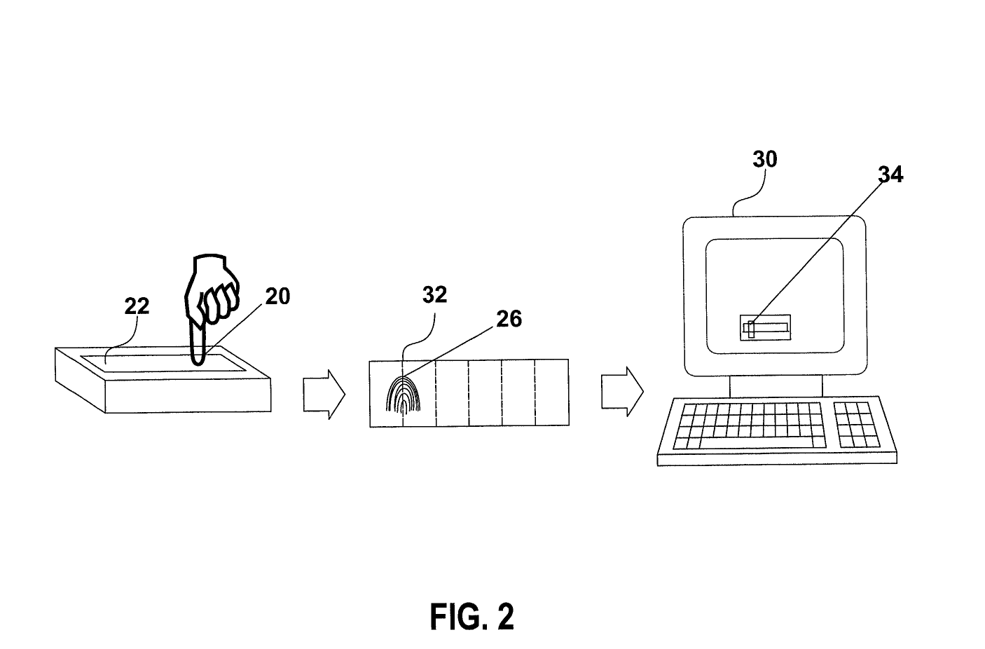

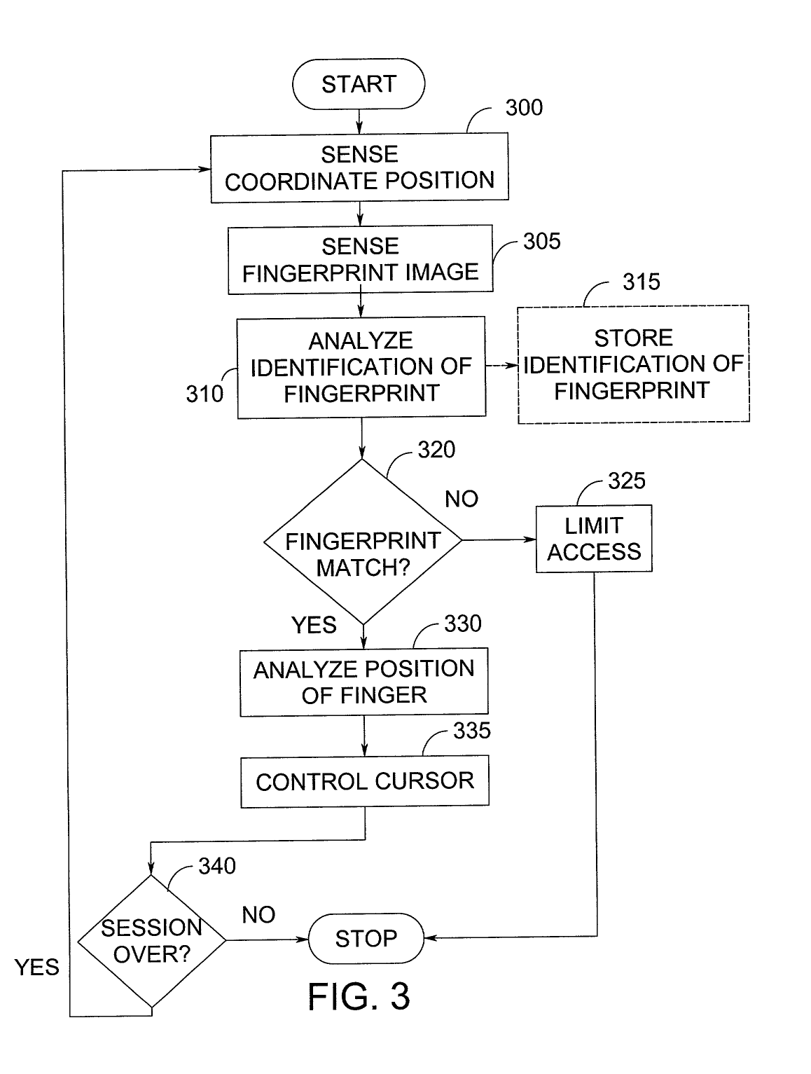

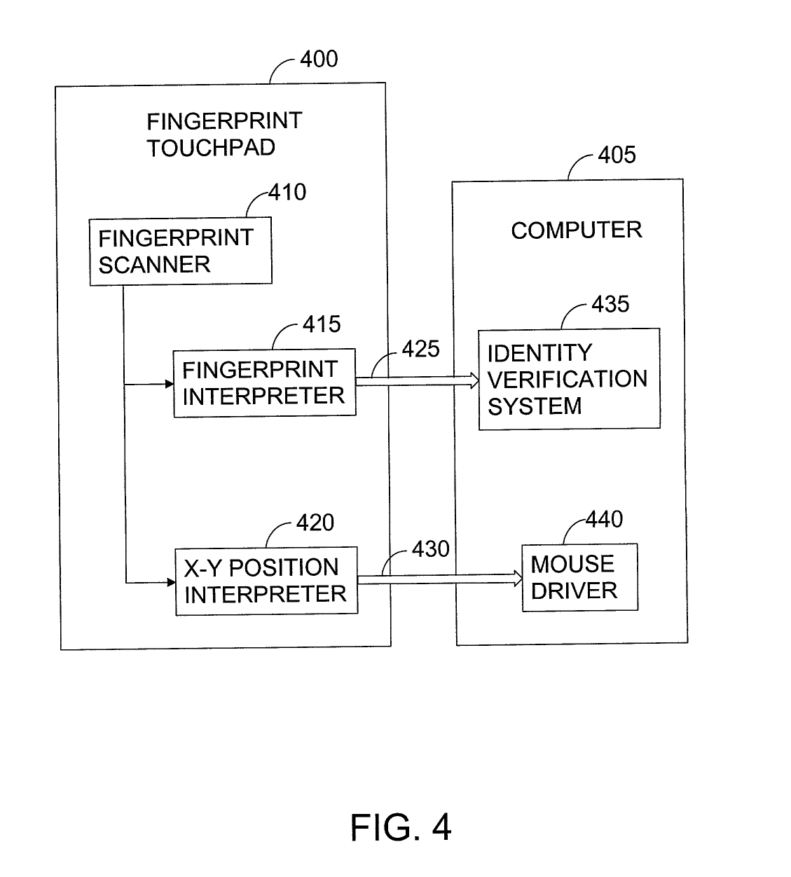

FIGS. 1-4 show exemplary embodiments of apparatus and method for sensing a fingerprint image and position. FIG. 1 shows an embodiment of the invention that senses a two-dimensional position. FIG. 2 shows an embodiment of the invention that senses a one-dimensional position. FIG. 3 shows the invention as directed to a method for sensing fingerprint image and position substantially simultaneously. FIG. 4 shows a block diagram of a two-dimensional fingerprint position interpreter and finger print scanner. These figures, as will be discussed individually, embody the basic principles of the methods or apparatus of the present invention for using a single touch-sensitive pad to sense and match a fingerprint for security purposes while at the same time sensing positional data to control a cursor on a display. Specifically, these examples show a device that is capable of performing both functions simultaneously.

FIG. 1 shows an exemplary embodiment of the present invention directed to a two-dimensional fingerprint sensor and position controller. As shown, the end joint of a finger 20 is placed in contact with a contact surface 22. The contact surface 22 includes position sensors capable of sensing a two-dimensional coordinate position 24. The position sensors may be of any type known to one skilled in the art. In addition, the contact surface 22 includes identification sensors capable of sensing a fingerprint image 26. The identification sensors may also be of any type known to one skilled in the art. In one preferred embodiment, the contact surface includes sensors of a type capable of sensing both a coordinate position and a fingerprint image. A processor receives the sensed coordinate position information 24 and causes the cursor 28 to appear in a correlated position on the display 30 of a computer. The processor receives the sensed fingerprint image 26 and compares it to stored reference fingerprint images. If the sensed image matches a stored reference image, access to the computer is allowed.

In one exemplary preferred embodiment, it appears to a user that position and image-sensing operations are performed substantially simultaneously and continuously even though they are performed sequentially. In this embodiment, the position and image sensing are performed alternately and repeatedly at predefined intervals. The interval length is short enough so that it appears that the operations are performed simultaneously. For example, if sampling and processing of position and image information are each performed once every 100 milliseconds, with the second operation following the first by 50 milliseconds (assuming that each operation requires less than 50 milliseconds to complete), then both operations will be performed once every 100 milliseconds, giving the appearance that the operations occur simultaneously and continuously. It will be appreciated by one skilled in the art that these time intervals are exemplary and that other intervals can be used to make it appear to a user that the operations are performed substantially simultaneously. For purposes of this invention, if it appears to a user that the position and image sensing operations are being performed substantially simultaneously, then the operations may be considered to be substantially simultaneous.

In an alternate embodiment, the sensing and analyzing of the fingerprint steps 305, 310 shown in FIG. 3 may be performed only once rather than continuously.

FIG. 2 shows an exemplary embodiment of the present invention directed to a one-dimensional fingerprint sensor and position controller. As shown, the end joint of a finger 20 is placed in contact with a contact surface 22. The contact surface 22 includes position sensors capable of sensing a one-dimensional coordinate position 32 and identification sensors capable of sensing a fingerprint image 26. A processor receives the sensed coordinate position information 32 and causes the sliding knob 34 to appear in a correlated position along a horizontal axis on a graphic object on the display 30 of a computer. In an alternate preferred embodiment, sensed coordinate position information 32 causes correlated movement of a visual cue along a vertical axis. It will be recognized by one skilled in the art that the sliding knob 34 is exemplary and that other visual cues may be used.

In an alternate preferred embodiment, the contact surface 22, as shown in FIG. 1, includes position sensors capable of sensing a three-dimensional coordinate position 24. The three-dimensional coordinate position sensors may be of any design known to one skilled in the art.

FIG. 3 shows the invention as directed to a method for sensing fingerprint image and position substantially simultaneously. As shown, a coordinate position 300 and fingerprint image 305 are sensed and the fingerprint image analyzed 310. In one preferred embodiment, the fingerprint image is stored in a memory 315. If the sensed fingerprint image does not match a stored reference image 320, access to the computer is limited or denied 325. If, on the other hand, the image matches a stored reference image, the coordinate position of the finger is analyzed 330 and used to control the position of a visual cue 335, such as a cursor, on a display. Steps 300-335 are repeated continuously until a user session ends 340.

In one preferred embodiment, if the sensed fingerprint image matches a stored reference image, access is granted to the computing system, but access is limited, or in extreme circumstances, prevented, according to a predefined mode of access associated with the reference image. For example, a reference image may be allowed to read but not modify data stored in the computing system. Another example is that access may be granted to only certain files, directories, programs, data, or portions thereof. In an alternate embodiment, if a sensed fingerprint image does not match a stored reference image, the access limitation is that the sensed coordinate position of a finger will not operate to control the position of the cursor on a display screen.

In an alternate embodiment of the invention, the primary purpose of the security system might not be to limit or prevent access to all or part of a system, but rather to record who has had access to the system. In this embodiment, after the fingerprint has been identified 310, as shown in FIG. 3, the identification is stored in memory 315. In this embodiment, the lack of a fingerprint match may or may not limit access to the system.

FIG. 4 shows a block diagram of a fingerprint touch pad 400 and a computer 405. A fingerprint interpreter 415 and a two-dimensional position interpreter 420 read information from a fingerprint scanner 410. The information furnished by the fingerprint scanner 410 consists of a high resolution bit map of the surface of the fingerprint touch pad 400. The fingerprint interpreter 415 generates a sequence of characteristic data (“fingerprint map”) that represents the sensed fingerprint image. The identity verification system 435 in the computer 405 reads the fingerprint map and determines whether the fingerprint map matches a stored reference fingerprint image. The two-dimensional position interpreter 420 generates an x-y coordinate position of the center of the fingerprint map on the contact surface 22. In one preferred embodiment, the coordinate position is determined by computing the arithmetic center of mass for the fingerprint map. The mouse driver program 440 reads the x-y coordinate position and uses the information to control the position of a visual cue on a display screen. The embodiment shown in FIG. 4 is meant to be exemplary and variations thereof would be apparent to one skilled in the art.

It should be noted that although the present invention may be used to control a cursor as a visual display, an alternate embodiment does not include the visual display. This embodiment might be used for a “signing security” system in which a user uses his finger to sign his name on a touch pad. The system would verify both the fingerprint and the signature. No visual display, however, would be necessary.

The terms and expressions that have been employed in the foregoing specification are used as terms of description, not of limitation, and are not intended to exclude equivalents of the features shown and described or portions of them. The scope of the invention is defined and limited only by the claims that follow.

What is claimed is:

1. A system comprising:
(a) at least one position sensor for sensing a coordinate position of a finger within a predefined space;
(b) at least one identification sensor for sensing an identification of said finger; and
(c) a processor for receiving information from said at least one position sensor and said at least one identification sensor, said processor for analyzing said identification and said coordinate position of said finger.

2. The system of claim 1, said processor for continually analyzing said identification.

3. The system of claim 1, said processor for continually analyzing said coordinate position of said finger.

4. The system of claim 1, wherein said system is for sensing a fingerprint and controlling a cursor on an associated computing system.

5. The system of claim 1, further comprising:
(a) a display screen;
(b) a cursor having a cursor position on said display screen; and
(c) said cursor position being correlated to said coordinate position of said finger.

6. The system of claim 1, wherein said at least one position sensor and said at least one identification sensor are a single sensor.

7. The system of claim 1, wherein said predefined space is one-dimensional.

8. The system of claim 1, wherein said predefined space is two-dimensional.

9. The system of claim 1, wherein said predefined space is three-dimensional.

10. The system of claim 1, wherein said processor substantially simultaneously analyzes said identification and said coordinate position of said finger.

11. The system of claim 1, wherein access is based on said identification representation matching a predefined criteria.

12. The system of claim 1, wherein said system includes memory for storing said identification representation.

13. A computer access security system for sensing fingerprints and controlling a cursor on an associated computer display screen, said security system comprising:
(a) at least one sensor, each said sensor capable of sensing finger contact and representing said finger contact as a signal;
(b) a processor for receiving said signal from said at least one sensor;
(c) a cursor displayed on said display screen, said cursor controllable by said processor according to said signal; and
(d) an identification representation of said finger, said identification representation constructed by said processor according to said signal.

14. The security system of claim 13, wherein access is based on said identification representation matching a predefined criteria.

15. The security system of claim 13, wherein said system includes memory for storing said identification representation.

16. A method for sensing fingerprints and controlling a cursor on an associated computing system, which comprises the steps of:
(a) sensing a coordinate position of a finger within a predefined space;
(b) sensing an identification of said finger;
(c) analyzing an identification of said finger;
(d) analyzing said coordinate position of said finger; and
(e) controlling said cursor displayed on said associated computing system according to said coordinate position.

17. The method of claim 16, wherein said step of sensing said coordinate position within said predefined space further comprises the step of sensing said coordinate position of said finger within a three-dimensional predefined space.

18. The method of claim 16, wherein said step of sensing the coordinate position is performed before said step of sensing the identification of said finger.

19. The method of claim 16, wherein said step of sensing the identification of said finger is performed before said step of sensing the coordinate position.

20. The method of claim 16, wherein said step of analyzing the identification of said finger and the step of analyzing the coordinate position occur substantially simultaneously.

21. The method of claim 16, further comprising the step of limiting access to said associated computing system based on said identification.

22. The method of claim 16, further comprising the step of limiting said step of controlling said cursor based on said identification.

23. The method of claim 16, further comprising the step of storing said identification of said finger in memory.

24. A system comprising:
(a) at least one position sensor for sensing a coordinate position of a finger within a predefined space;
(b) at least one identification sensor for sensing an identification of said finger;
(c) an identification processor for receiving information from said at least one identification sensor and analyzing said identification; and
(d) a position processor processor for receiving information from said at least one position sensor and analyzing said coordinate position of said finger.

25. The system of claim 24 wherein said identification processor and said position processor are a single processor.

26. The system of claim 24 wherein said at least one position sensor and said at least one identification sensor are a single sensor.
